(19) United States
(12) Patent Application Publication
(10) Pub. No.: US 2009/0138800 A1
(43) Pub. Date: May 28, 2009

(54) APPARATUS, METHOD AND COMPUTER-READABLE STORAGE MEDIUM FOR DIRECTING OPERATION OF A SOFTWARE APPLICATION VIA A TOUCH-SENSITIVE SURFACE

(75) Inventors: Michael J. Anderson, Vancouver (CA); George Kovacs, Vancouver (CA); Martin L. Terry, Richmond (CA); Warren S. Edwards, Surrey (CA); Diana H. Chaytor, Vancouver (CA)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited

(21) Appl. No.: 12/140,601

(22) Filed: Jun. 17, 2008

Related U.S. Application Data
(60) Provisional application No. 60/989,868, filed on Nov. 23, 2007.

(51) Int. Cl. G06F 3/041

(52) U.S. Cl. 715/702

(57) ABSTRACT

An apparatus is provided that includes a processor configured to receive data representative of points on a touch-sensitive surface with which an object comes into contact to initiate and carry out a trace or movement interaction with the surface. In this regard, the trace is defined by a shape formed by the points, and the movement interaction is defined by movement reflected by the points. The processor is configured to determine if the contact is initiated to carry out a trace or movement interaction based on the data. The contact is initiated to carry out a trace if contact of the object is made and the object is held substantially in place for a period of time, the determination being made. The processor is then configured to interpret the data based on the determination to thereby direct interaction with media presented on the corresponding display based on the interpretation.

### CROSS-REFERENCE TO RELATED APPLICATIONS

The present application claims priority to U.S. Provisional Patent Application No. 60/989,868, entitled: Touch-Based User Interface for a Computer System and Associated Gestures for Interacting with the Same, filed on Nov. 23, 2007, the content of which is incorporated herein by reference.

### FIELD OF THE INVENTION

The present invention generally relates to user interface and methods for interacting with a computer system, and more particularly, to a touch-based user interface and method for interacting with a medical-imaging system.

### BACKGROUND OF THE INVENTION

In the field of medical imaging, prior to the digitization of medical imaging, medical-imaging users (e.g., Radiologists) would analyze physical film printed images in light boxes, and use physical devices such as magnifying glasses, rulers, grease pencils, and their hands to manipulate the physical printed medical images in order to interpret and diagnose the images. With the digitization of medical imaging, the physical film became a digital image, displayable on a computer monitor. A medical-imaging system became a computer application or collection of computer applications, which require a computer or computers to operate. At present, medical-imaging systems are interacted with through a keyboard and mouse. Commands to the medical-imaging system are invoked through keyboard and/or mouse interactions.

Requiring interactions to be performed using a keyboard and mouse is not as intuitive as working directly with objects using the hands or other physical objects (e.g. ruler, grease pencil). In addition, early computing systems were not powerful enough, nor feature-rich to warrant more efficient methods of human-computer interaction other than through keyboard and/or mouse inputs. However, with the availability of ever increasing computer power, and the increase in system capabilities, there is a need for additional techniques of interacting with computer systems such that human-computer interaction is not restricted by simple keyboard and/or mouse inputs. A move toward a much more natural, intuitive, efficient method of interaction is required.

### SUMMARY OF THE INVENTION

In light of the foregoing background, exemplary embodiments of the present invention provide an improved apparatus and method for more intuitively and efficiently interacting with a computer system, such as a medical-imaging system. According to one aspect of exemplary embodiments of the present invention, an apparatus is provided that includes a processor configured to receive data representative of points on a touch-sensitive surface with which an object comes into contact to initiate and carry out a trace or movement interaction with the surface. In this regard, the trace is defined by a shape formed by the points, and the movement interaction is defined by movement reflected by the points. The processor is configured to determine, independent of a corresponding display or any media presented thereon, if the contact is initiated to carry out a trace or movement interaction based on the data. The contact is initiated to carry out a trace if contact of the object is made and the object is held substantially in place for a period of time, the determination being made. The processor is then configured to interpret the data based on the determination to thereby direct interaction with media presented on the corresponding display based on the interpretation, which may be effectuated by directing operation of a software application such as medical imaging software.

More particularly, for example, the processor may be configured to receive data to carry out a trace defined by an S-shape, F-shape, G-shape, K-shape or M-shape. In such instances, the software application may be directed to launch a study-worklist application when the trace is defined by an S-shape, launch a patient finder/search application when the trace is defined by an F-shape, direct an Internet browser to an Internet-based search engine when the trace is defined by an G-shape, launch a virtual keypad or keyboard when the trace is defined by an K-shape, or launch a measurement tool when the trace is defined by a M-shape.

Also, for example, the processor may be configured to receive data to carry out a trace defined by an A- or arrow shape, a C-shape or an E-shape, and interpret the data to direct a software application to annotate media presented on the corresponding display, including presentation of an annotations dialog based on the shape defining the trace. In addition, for example, the processor may be configured to receive data to carry out a trace defined by a checkmark-, J- or V-shape, and interpret the data to direct a software application to mark a study including the presented media with a status indicating interaction with the study has been completed. Further, for example, the processor may be configured to receive data to carry out a trace defined by a D-shape, and interpret the data to direct a software application to launch a dictation application. In another example, the processor may be configured to receive data to carry out a movement interaction defined by a two-handed, multiple-finger contact beginning at one side of the touch-sensitive surface and wiping to the other side of the surface, and interpret the data to direct a software application to close open media presented on the corresponding display.

In yet another example, the processor may be configured to receive data to carry out a movement interaction defined by a two-handed, single-finger contact whereby the finger of one hand is anchored substantially in place while dragging the finger of the other hand toward or away from the anchored finger in a substantially horizontal, vertical or diagonal direction. In these instances, the processor may be configured to interpret the data to direct a software application to interactively adjust a contrast of media presented on the corresponding display when the direction is substantially horizontal, adjust a brightness of media presented on the corresponding display when the direction is substantially vertical, or adjust both the contrast and brightness of media presented on the corresponding display when the direction is substantially diagonal. In similar instances, when the software application comprises medical imaging software, the processor may be configured to interpret the data to direct the medical imaging software to interactively adjust a window and/or level of media presented on the corresponding display. That is, the processor may be configured to direct the software to interactively adjust the window when the direction is substantially horizontal, adjust the level when the direction is substantially vertical, or adjust both the window and level when the direction is substantially diagonal.

In a further example, the processor may be configured to receive data to carry out a movement interaction defined by a single-handed, multiple-finger contact and dragging in the direction of another object, and interpret the data to direct a software application to perform an action with respect to the other object, such as by moving media presented on the corresponding display to another device or apparatus, software application or display, or directing an action with respect to another device or apparatus, software application or display. And additionally or alternatively, for example, the processor may be configured to receive data to carry out a movement interaction defined by a single or two-handed, multiple-finger contact and release. In this instance, the processor may be configured to interpret the data to direct a software application to open a menu of the software application, the menu being navigable by a user via single-finger contact and release relative to one of a number of options presented in the menu.

In addition to or in lieu of the foregoing, the processor may be further configured to receive data representative of points on the touch-sensitive surface with which a given object comes into contact to carry out an interaction with media presented on the corresponding display. The given object may comprise the same or a different object than that which comes into contact to initiate or carry out the trace or movement interaction. In this regard, the given object may be a first object (e.g., stylus) for effectuating a first type of interaction with the media, a second object (e.g., rectangular object) for effectuating a second type of interaction with the media, or a third object (e.g., closed-shaped object) for effectuating a third type of interaction with the media. The processor may be configured to determine if the given object is the first, second or third object based on the data representative of points on the touch-sensitive surface with which the given object comes into contact, and independent of separate user input. The processor may then be configured to enter a mode for interacting with the media based on the determination if the given object is the first, second or third object.

According to other aspects of exemplary embodiments of the present invention, a method and computer-readable storage medium are provided. Exemplary embodiments of the present invention therefore provide an improved apparatus, method and computer-readable storage medium for interacting with media presented on a display, or otherwise directing operation of a software application. As indicated above, and explained below, exemplary embodiments of the present invention may solve problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of an apparatus configured for operation in accordance with embodiments of the present invention;

FIGS. 2a and 2b are schematic block diagrams of a touch-sensitive surface and a number of objects that may come into contact with that surface to effectuate a trace or movement interaction, according to exemplary embodiments of the present invention;

FIGS. 3a-3h illustrate various exemplary traces that may be interpreted by the apparatus of exemplary embodiments of the present invention;

FIGS. 4a-4g illustrate various exemplary movements that may be interpreted by the apparatus of exemplary embodiments of the present invention; and

FIGS. 5 and 6 illustrate exemplary displays of medical-imaging software whose functions may be at least partially directed via traces and movements relative to a touch-sensitive surface, according to exemplary embodiments of the present invention

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, references may be made herein to directions and orientations including vertical, horizontal, diagonal, right and left; it should be understood, however, that any direction and orientation references are simply examples and that any particular direction or orientation may depend on the particular object, and/or the orientation of the particular object, with which the direction or orientation reference is made. Like numbers refer to like elements throughout.

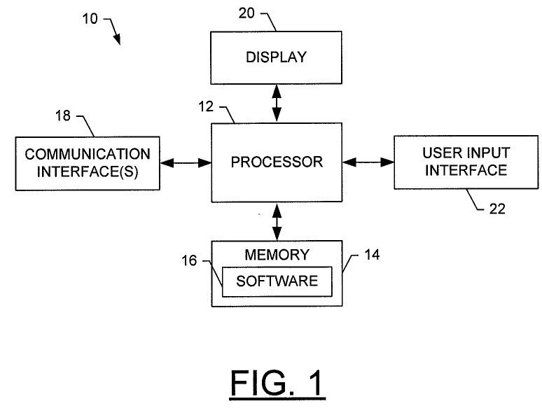

Referring to FIG. 1, a block diagram of one type of apparatus configured according to exemplary embodiments of the present invention is provided. The apparatus and method product of exemplary embodiments of the present invention will be primarily described in conjunction with medical-imaging applications. It should be understood, however, that the method and apparatus of embodiments of the present invention can be utilized in conjunction with a variety of other applications, both in the medical industry and outside of the medical industry. Further, the apparatus of exemplary embodiments of the present invention includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention.

Generally, the apparatus of exemplary embodiments of the present invention may comprise, include or be embodied in one or more fixed electronic devices, such as one or more of a laptop computer, desktop computer, workstation computer, server computer or the like. Additionally or alternatively, the apparatus may comprise, include or be embodied in one or more portable electronic devices, such as one or more of a mobile telephone, portable digital assistant (PDA), pager or the like.

As shown in FIG. 1, the apparatus 10 of one exemplary embodiment of the present invention may include a processor 12 connected to a memory 14. The memory can comprise volatile and/or non-volatile memory, and typically stores content, data or the like. In this regard, the memory may store content transmitted from, and/or received by, the apparatus. The memory may also store one or more software applications 16, instructions or the like for the processor to perform steps associated with operation of the entity in accordance with exemplary embodiments of the present invention (although any one or more of these steps may be implemented in any combination software, firmware or hardware). This software may include, for example, a gesture-recognition engine configured to receive and interpret data from a touch-sensitive surface for directing performance of one or more functions of the apparatus. In addition, the software may include software (e.g., medical-imaging software, Internet browser, etc.) one or more operations of which may be directed by the gesture-recognition engine (and, hence, the user of the apparatus via interaction with a touch-sensitive surface).

In addition to the memory 14, the processor 12 may also be connected to at least one interface or other means for displaying, transmitting and/or receiving data, content or the like. In this regard, the interface(s) may include at least one communication interface 18 or other means for transmitting and/or receiving data, content or the like, such as to and/or from other devices and/or networks coupled to the apparatus. In addition to the communication interface(s), the interface(s) may also include at least one user interface that may include one or more wireline and/or wireless (e.g., Bluetooth) earphones and/or speakers, a display 20, and/or a user input interface 22. The user input interface, in turn, may comprise any of a number of wireline and/or wireless devices allowing the entity to receive data from a user, such as a microphone, an image or video capture device, a keyboard or keypad, a joystick, or other input device.

According to a more particular exemplary embodiment, the user input interface 22 may include one or more biometric sensors, and/or a touch-sensitive surface (integral or separate from a display 20). The biometric sensor(s), on the other hand, may include any apparatus (e.g., image capture device) configured to capture one or more intrinsic physical or behavioral traits of a user of the apparatus such as to enable access control to the apparatus, provide presence information of the user relative to the apparatus, or the like.

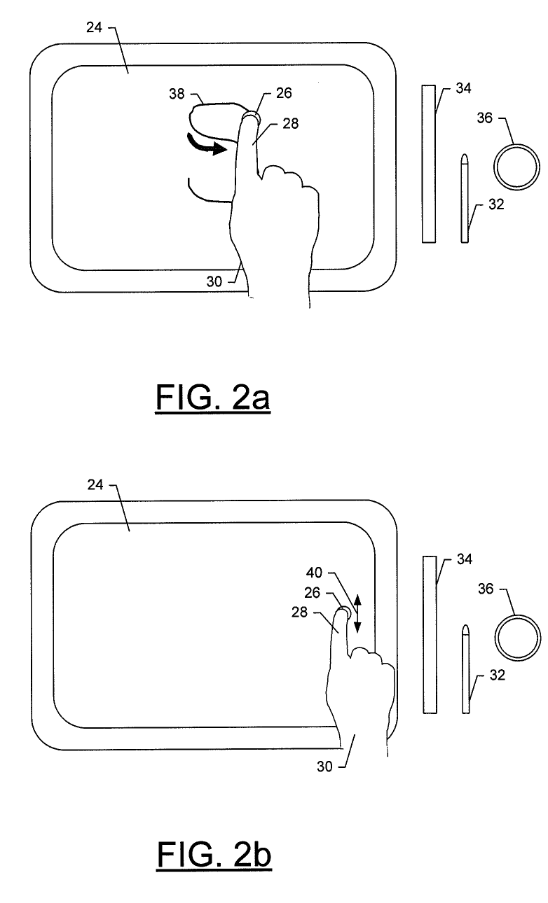

Referring to FIGS. 2a and 2b, the touch-sensitive surface 24 may be integral to the display 20 of the apparatus 10 (forming a touch-sensitive display) or may be separate from the display, and may be implemented in any of a number of different manners. In one embodiment, for example, the touch-sensitive surface may be formed by an optical position detector coupled to or otherwise in optical communication with a surface (e.g., surface of a display).

The touch-sensitive surface 24 may be configured to detect and provide data representative of points on the surface with which one or more objects come into contact (points of contact 26), and as well as the size of each point of contact (e.g., through the area of the contact point, the shadow size of the contact point, etc.). These objects may include one or more fingers 28 of one or both hands 30 of a user (or more generally one or more appendages of a user), as well as one or more objects representing instruments otherwise designed for use in paper-based systems. Objects representing instruments may include, for example, a stylus 32, pen or other similarly-shaped object (e.g., felt-tipped cone-shaped object) representing a writing instrument (e.g., grease pencil), a rectangular object 34 representing a ruler, a closed-shaped (e.g., rectangular, circular, etc.) object 36 representing a magnifying glass, or the like.

In accordance with exemplary embodiments of the present invention, the touch-sensitive surface 24 may be configured to detect points of contact 26 of one or more objects (fingers 28, stylus 32, rectangular object 34, closed-shaped object 36, etc.) with the surface. An accompanying gesture-recognition engine (software application 16), then, may be configured to receive and interpret data representative of those points of contact, and interpret those points of contact (including concatenated points of contact representative of a trace 38 as in FIG. 2a or movement 40 as in FIG. 2b) into commands or other instructions for directing performance of one or more functions of the apparatus 10. At any instant in time, the touch-sensitive surface and gesture-recognition engine may be capable of detecting and interpreting a single touch point (single-touch) or multiple simultaneous touch points (multi-touch).

Generally, the apparatus 10 including the touch-sensitive surface 24 and gesture-recognition engine (software application 16) are capable of distinguishing between a trace 38 (e.g. drawing the letter G), and a movement 40 or other interaction (e.g., interaction interpreted similar to a mouse-click and/or mouse-click-drag). In this regard, the user may touch the surface with a single finger (the surface detecting a point of contact 26), and hold that finger substantially in place for a period of time (e.g., 100 ms) (this interaction may be referred to herein as “delay-to-gesture” interaction). The gesture-recognition, then, may be configured to interpret the point of contact and holding in position of that point of contact as notification of a forthcoming single-finger gesture trace. The gesture-recognition engine may respond to the notification by directing removal or hiding of a cursor by a graphical user interface (GUI) presented on the display 20 of the apparatus. This, then, may indicate that the apparatus is ready to accept a single-finger trace. The next point of contact or consecutive points of contact, then, may be interpreted by the gesture-recognition engine as a trace instead of a movement interaction.

During a trace 38, the gesture-recognition engine may respond by drawing a faint outline of the trace on the display 20 as it is performed, such as to indicate to the user the trace being performed, and that a trace is being performed. During a movement 40, the gesture-recognition engine may respond by drawing a faint symbol on the display near the touch point(s) to indicate to the user the movement being performed, and that a particular movement is being performed, (e.g., a faint bullseye symbol may appear under the stationary finger during a window/level gesture, providing feedback to the user that the window/level gesture is being performed).

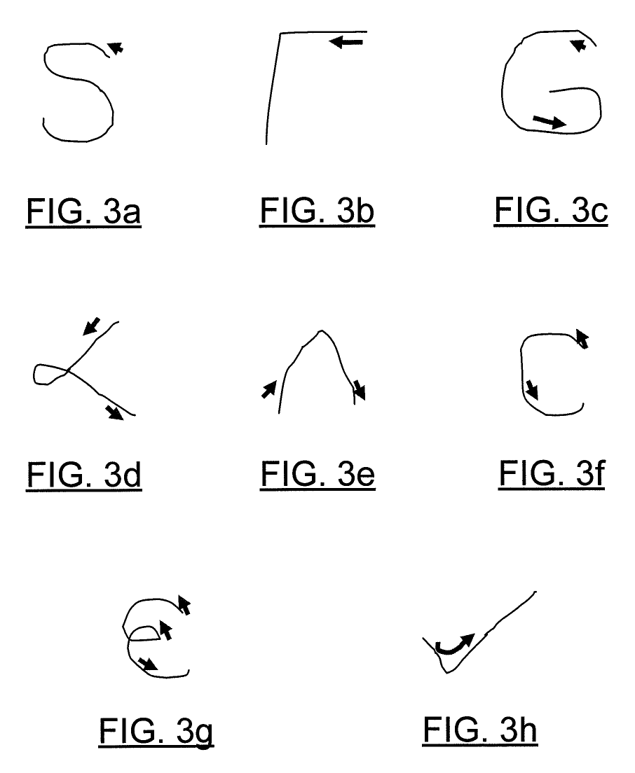

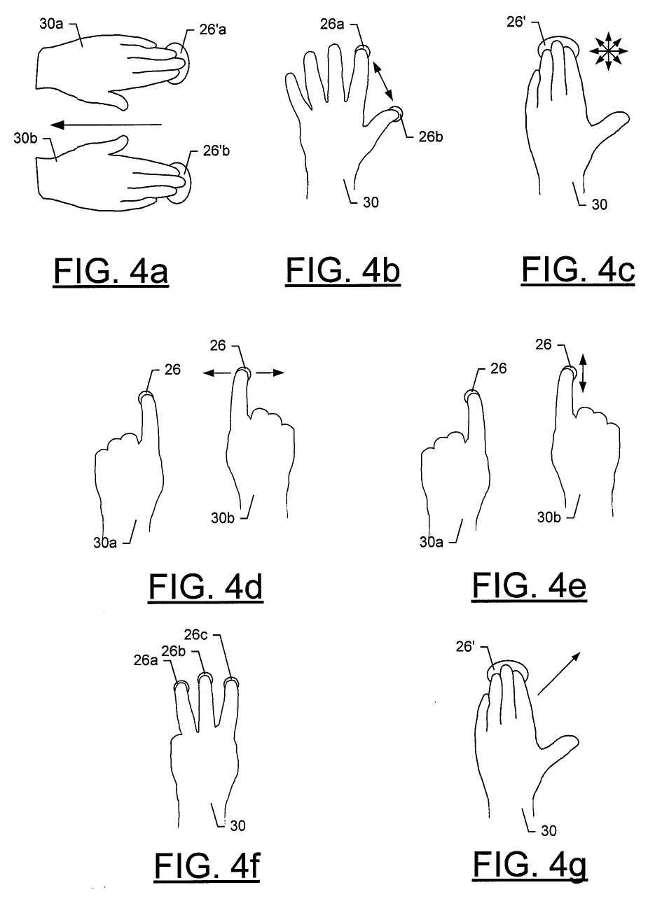

Reference will now be made to FIGS. 2a and 2b, as well as FIGS. 3a-3h and 4a-4g, illustrating a number of exemplary gestures of a user interacting with the touch-sensitive surface 24, and the accompanying interpretation of the gesture-recognition engine (software application 16). In this regard, FIGS. 2a and 3a-3h illustrate exemplary single-finger traces 38 that may be initiated by the aforementioned delay-to-gesture interaction. FIGS. 2b and 4a-4g, on the other hand, illustrate exemplary single or multiple-finger (from one hand 30 or both hands 30a, 30b) movement 40 interactions.

As shown in FIGS. 2a and 3a-3h, single-finger traces 38 may resemble alpha-numeric characters, each of which may be interpreted by the gesture-recognition engine (software application 16) into commands or other instructions for directing performance of one or more functions of the apparatus 10 associated with the respective character. These traces and associated “character commands” may include one or more of the following:

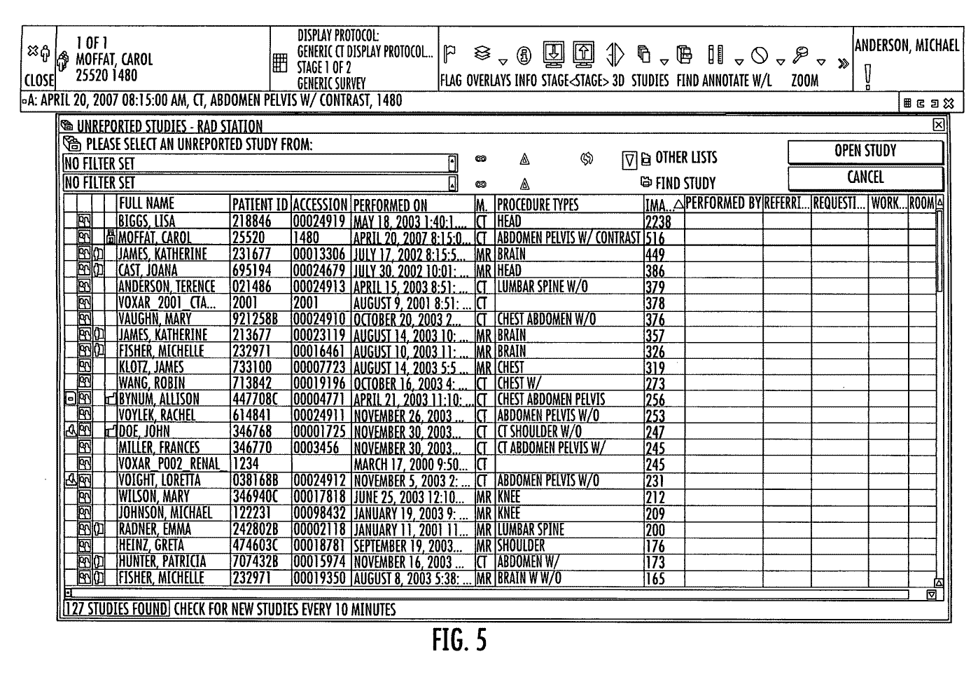

(a) An S-shaped trace (see FIGS. 2a and 3a) directing medical-imaging software to launch a study-worklist application (see, e.g., FIG. 5);

(b) An F-shaped trace (see FIG. 3b) directing the medical-imaging software to launch a patient finder/search application;

(c) A G-shaped trace (see FIG. 3c) directing the apparatus 10 to launch an Internet browser (if not already operating) and direct the browser to an Internet-based search engine (e.g., Google™);

(d) A K-shaped trace (see FIG. 3d) directing the apparatus (or operating software) to launch a virtual keypad or keyboard, which may be presented by the display 20, and in a more particular example by an integral display and touch-sensitive surface 24;

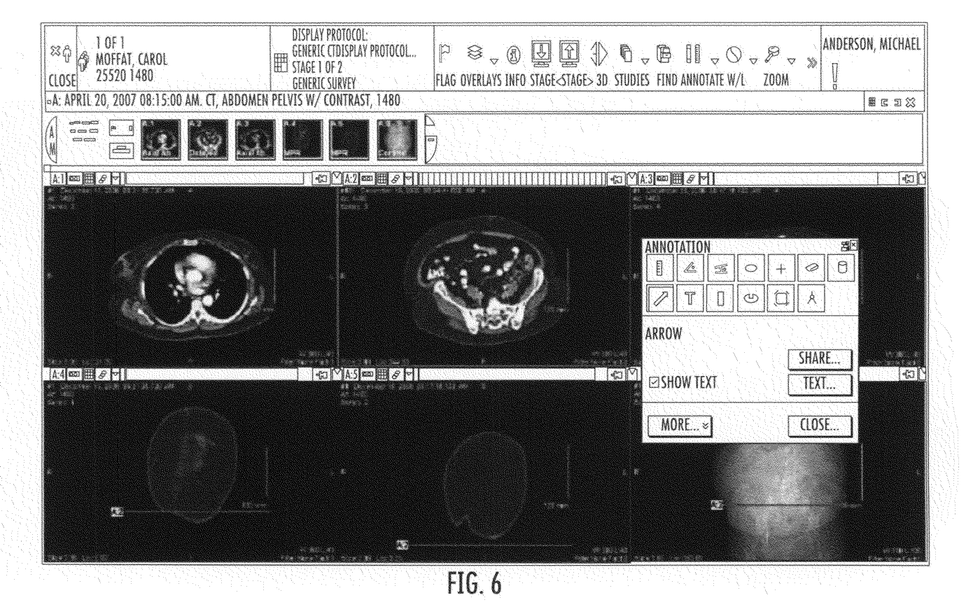

(e) Annotation-directed traces directing the medical-imaging software or other appropriate software to annotate an opened image or other document in one or more manners whereby, for example, a trace associated with a particular annotation may direct the appropriate software to set a displayed annotations dialog to a particular mode whereby, when one instance of the particular annotation is desired, the user may (after setting the annotations to the respective mode) contact the touch-sensitive surface to form the particular annotation; or when more than one instance is desired, the user may keep one finger in contact on a displayed annotation dialog (see, e.g., FIG. 6), and with another finger, form each instance of the particular annotation in a similar manner to a single instance. These annotation-directed traces may include one or more of the following, for example (although it should be understood that these traces are merely examples, and that the apparatus may be configured to recognize any of a number of other traces without departing from the spirit and scope of the present invention):
(1) An A- or arrow-shaped trace (see FIG. 3e) to enter an arrow annotation mode from which the user may (after setting the annotations to the arrow annotation mode) contact the touch-sensitive surface where the head of the arrow should appear, and drag the user's contacting finger therefrom to form the tail;
(2) A C-shaped trace (see FIG. 3f) to enter an ellipse mode from which the user may (after setting the annotations to the ellipse mode) contact the touch-sensitive surface where the top-left of the circle or ellipse should begin, and drag the user's contacting finger to form the circle or ellipse; or
(3) An E-shaped trace (see FIG. 3g) to enter an erase mode from which the user may (after setting the annotations to the erase mode) contact the touch-sensitive surface and drag the user's contacting finger to define an area to erase;

f) A checkmark-, J-, V- or other similarly-shaped trace (see FIG. 3h) directing the medical-imaging software to mark a study reported, dictated, or some other status indicating work with the study has been completed;

g) An M-shaped trace directing the medical-imaging software or other appropriate software to launch a measurement tool; or

h) A D-shaped trace directing the medical-imaging software or other appropriate software to launch a dictation application (with which the user may at least partially interact with a microphone of the apparatus's user input interface 22).

Similar to single-finger traces 38, single or multiple-finger (from one hand 30 or both hands 30a, 30b) movement 40 interactions may also be interpreted by the gesture-recognition engine (software application 16) into commands or other instructions for directing performance of one or more functions of the apparatus 10 associated with the respective movements. Movement interactions may be considered “interactive” in the sense that the interactions direct performance of functions during the interaction, and/or “command-based interactions” in the sense that the interactions direct performance of function(s) following the interaction (similar to single-finger trace commands). Referring now to FIGS. 2b and 4a-4g, these movement interactions and associated directed-functions may include one or more of the following (although it should be understood that these movement interactions are merely examples, and that the apparatus may be configured to recognize any of a number of other movement interactions without departing from the spirit and scope of the present invention):

a) A single-finger touching (or other touch resulting in a similar-sized point of contact 26) and dragging in a horizontal or vertical direction within a particular area (e.g., along the right side of the touch-sensitive surface 24) to direct medical-imaging software or other appropriate software to scroll through or within one or more displayed images, documents or other windows in the respective direction (see FIG. 2b, vertical scroll, or “image scroll” in the context of certain medical-imaging software);

b) A two-handed, multiple-finger touching (fingers on each hand held together resulting in a points of contact 26′a, 26′b larger than single-finger touching) beginning at one (e.g., right) side of the touch-sensitive surface 24 and wiping to the other (e.g., left) side of the surface such as for a distance at least half the width of the surface to direct the medical-imaging software to close an open study (see FIG. 4a) (this gesture being similar to grabbing an open, displayed study and sliding it off of the display);

c) A single or two-handed, multiple-finger touching (fingers apart from one another resulting in single-finger-sized points of contact) and dragging apart or together to direct medical-imaging software or other appropriate software to interactively zoom in or out, respectively, within one or more displayed images, documents or other windows in the respective direction (see FIG. 4b);

d) A single-handed, multiple-finger touching (fingers held together) and dragging in any direction to direct medical-imaging software or other appropriate software to interactively pan within one or more displayed images, documents or other windows in the respective direction (see FIG. 4c);

e) A two-handed, single-finger touching whereby the user anchors the finger of one hand substantially in place, while dragging the finger of the other hand toward or away from the anchored finger in a horizontal and/or vertical direction, horizontal movement directing medical-imaging software or other appropriate software to interactively adjust the contrast (or more particularly, the “window” in the context of medical imaging) of one or more displayed images (see FIG. 4d), vertical movement directing medical-imaging software or other appropriate software to interactively adjust the brightness (or, more particularly, the “level” in the context of medical imaging) of one or more displayed images (see FIG. 4e), and diagonal movement directing medical-imaging software or other appropriate software to interactively adjust both the contrast and brightness (window and level);

f) A single or two-handed, multiple-finger touch (fingers apart from one another resulting in single-finger-sized points of contact) and release (from contact with the touch-sensitive surface 24) to direct medical-imaging software or other appropriate software to open a particular menu (see FIG. 4f), from which the user may navigate via single-finger touching and releasing relative to desired menu options;

g) A single-handed, multiple-finger touching (fingers held together) and dragging in the direction of another object (including a shortcut or other representation—e.g., icon—of the other object) to move or “throw” one or more displayed or otherwise active images, documents, software applications, actions or the like to the respective other object (see FIG. 4g); where the other object may be another local or remote software application, display, system or the like (relative to the medical-imaging software or other appropriate software to which the movement interaction is directed, the display 20 presenting the respective software, or the like); for example, if an additional display is positioned to the upper right of the main display—in the same or remote location from the display, this movement (including the user dragging their contacting fingers up and right) may direct the apparatus to move displayed image(s) or an active application to the upper-right display; this movement may be similar to the interactive pan but may be distinguished by the system based on the relative speed of movement (e.g., interactive panning being invoked by slower movement); this movement may also direct performance of further functions depending on the software application/display to which the image(s), document(s) or the like are “thrown;” or

h) A single-handed, multiple-finger touching (fingers held together) and dragging in any direction to direct medical-imaging software or other appropriate software to interactively rotate a three-dimensional volume or image in the respective direction, which rotation may or may not continue following the user's dragging of their fingers; this movement is similar to that of the interactive pan, but may be distinguished by the system in the images to which the respective movements are applicable, based on the relative speed of movement, or in a number of other manners.

In the preceding description of “throwing” images, documents, software applications, actions or the like to another object such as a system, this other system may be, for example, a fixed or portable electronic device of another user (e.g., radiologist, cardiologist, technologist, physician, etc.), location or department (e.g., ER). In various instances, another system may be a communications system having the capability to email the images and/or connect to a communications device (e.g., mobile phone) using Voice over IP (VoIP), for example, to connect the user with another user. In either of these instances, the images, documents, software applications, actions or the like may be thrown to the other user such as for a consultation.

Further relative to the “throwing” feature, the object to which the images, documents, software applications, actions or the like are thrown may be predefined, or user-selected in any of a number of different matters. In one exemplary embodiment in which the object comprises the fixed or portable electronic device of another user, location or department, or a communications system configured to communicate with another user, location or department (or their electronic device), the software application may be preconfigured or configurable with one or more destinations where each destination may refer to a user, user type, location or department. In this regard, each destination may be configured into the software with one or more properties. These properties may include or otherwise identify, for example, the users, user types (e.g., “attending” “referring,” etc. in the context of a physician user), locations or departments (e.g., “ER” in the context of a hospital department, etc.), as well as one or more contact numbers or addresses (e.g., telephone number, email address, hostname or IP address, etc.) for those users, user types, locations or departments. Additionally, these properties may include, for example, one or more actions such as email, text message, call, upload or download (or otherwise send/receive or transfer), or the like.

In various instances, then, implementing the “throwing” feature may include the user performing the aforementioned single-handed, multiple-finger touching (fingers held together) and dragging in the direction of another object, which may correspond to one or more destinations. In instances in which the software is configured for multiple destinations, the other object may be a shortcut directing the medical-imaging software or other appropriate software to display shortcuts or other representations—e.g., icons—of those destinations. The user may then select a desired destination, such as by touching the respective shortcut or speaking a word or phrase associated with the desired destination into a microphone of the apparatus's user input interface 22 (the software in this instance implementing or otherwise communicating with voice-recognition software). Alternatively, the software may initially display shortcuts to the destinations, where the shortcuts may be in different directions relative to the user's multiple-finger touching such that the user may drag their fingers in the direction of a desired destination to thereby select that destination. Additionally or alternatively, the parameters of the destinations may include a unique dragging direction (e.g., north, northeast, east, southeast, south, southwest, west, northwest) such that, even without displaying the shortcuts, the user may perform the multiple-finger touching (fingers held together) and dragging in the direction associated with the desired destination to thereby select that destination.

On receiving selection of a destination, the software may perform the action configured for the selected destination, and may perform that action with respect to one or more displayed or otherwise active images, documents, software applications, or the like. For example, the software may email, text message or upload an active image, document, software application or the like to the selected destination; or may call the destination (via an appropriate communications system). In such instances, the destination, or rather the destination device, may be configured to open or otherwise display the received email, text message, image, document, software application or the like immediately, on-demand or on response to a periodic polling for new information or data received by the device; or may notify any users in the vicinity of an incoming call.

In addition to or in lieu of interpreting contact between the touch-sensitive surface 24 and the user's fingers, as indicated above, the apparatus may be configured to interpret contact between the touch-sensitive surface and one or more objects representing instruments otherwise designed for use in paper-based systems (e.g., stylus 32 representing a writing instrument, rectangular object 34 representing a ruler, closed-shaped object 36 representing a magnifying glass, etc). More particularly, for example, points of contact between the touch-sensitive surface and one or more of these objects may be interpreted to direct medical-imaging software or other appropriate software into a respective mode of operation whereby the respective objects may function in a manner similar to their instrumental counterparts. In this regard, the apparatus may be configured to identify a particular object based on its points of contact (and/or size of those points of contact) with the touch-sensitive surface, and direct the respective application into the appropriate mode of operation. For example, placing the stylus into contact with the touch-sensitive surface may direct the medical-imaging software or other appropriate software into an annotation mode whereby subsequent strokes or traces made with the stylus may be interpreted as electronic-handwriting annotations to displayed images, documents or the like. Also, for example, placing the rectangular object (ruler) into contact with the touch-sensitive surface may direct the medical-imaging software or other appropriate software into a measurement mode whereby the user may touch and release (from contact with the touch-sensitive surface 24) on the ends of the object to be measured to thereby direct the software to present a measurement of the respective object. And placing the closed-shaped object (magnifying glass) into contact with the touch-sensitive surface may direct the medical-imaging software or other appropriate software into a magnification mode whereby an image or other display underlying the closed-shaped object may be magnified.

To further illustrate exemplary embodiments of the present invention, consider the context of a user (e.g., radiologist, cardiologist, technologist, physician, etc.) interacting with a workstation (apparatus 10) operating medical-imaging software (software applications 16) to display and review medical images, and form a diagnosis based on those images. In this exemplary situation, the touch-sensitive surface 24 and display 20 of the workstation are configured to form a touch-sensitive display.

The user may begin interaction with the workstation by logging into the workstation, such as via one or more biometric sensors in accordance with an image-recognition technique. Once logged in, the user may perform a delay-to-gesture interaction to indicate a forthcoming trace, and thereafter touch the touch-sensitive display and trace an “S” character (S-shaped trace) to direct the software to recall the list of patients' images to analyze (the “worklist” and/or “studylist”). See FIGS. 2a and 3a, and resulting list of FIG. 5. The user may then select a patient to analyze and direct the software to display the patient's images. If the user touches the touch-sensitive display with one finger along the right edge of each image and slowly slides the user's finger down the right side of the image, the stack of images scrolls revealing each image slice of the patient. See FIG. 2b.

If the user touches an image on the touch-sensitive display with two fingers and slides those two fingers apart from one another, the software zooms in on the image; or slides those two fingers towards one other, the software zooms out on the image. See FIG. 4b). If the user single-handedly touches an image on the touch-sensitive display with multiple-fingers (fingers held together) and drags those fingers in a particular direction, the software pans the image in the respective direction. See FIG. 4c.

If the user touches an image on the touch-sensitive display with two fingers and keeps one finger stationary while the other finger moves in a relative horizontal and/or vertical (horizontal and vertical collectively a diagonal) direction to the stationary finger, the window and/or level of the image is interactively adjusted. See FIGS. 4d and 4e. If the user touches an image on the touch-sensitive display with one finger and traces a “C” character (C-shaped trace) on the touch-sensitive display (following a delay-to-gesture interaction), the software enters an ellipse annotation mode. The user may then identify a region (circle or ellipse) of interest on the image by touching the display where the circle should begin and dragging a finger across the display to increase the diameter of the circle, releasing the finger from the display to complete the region identification. And if the user touches an image on the touch-sensitive display with one finger and traces an “A” character or arrow shape (A-shaped trace) on the touch-sensitive display (following a delay-to-gesture interaction), the software enters an arrow annotation mode from which the user may (after setting the annotations to the arrow mode) contact the touch-sensitive display where the head of the arrow should appear, and drag the user's contacting finger therefrom to form the tail. See FIG. 3e.

If the user touches the touch-sensitive display with a number of fingers and sweeps the user's hand up and to the right across the touch-sensitive display, the patient's images are “thrown” and/or passed to another system, such as a communications system having the capability to email the images and/or connect to a communications device to, in turn, connect the user with another user for a consultation. See FIG. 4g. If the user touches the touch-sensitive display with one finger and traces a “D” character (D-shaped trace) on the touch-sensitive display (following a delay-to-gesture interaction), the software enters a “dictation mode” wherein the user may record a verbal analysis of the images.

Regardless of the interactions made between the user and the workstation, after the user has completed work on the respective patient's images, the user may touch the touch-sensitive display with one finger and trace a “checkmark” on the touch-sensitive display (following a delay-to-gesture interaction) so as to direct the software to mark the patient's images complete and “reported.” See FIG. 3h. The user may then touch the touch-sensitive display with two hands and quickly moves them from right to left in a sweeping motion to direct the software to close the patient's images (“wiped from the touch-sensitive display”). See FIG. 4a.

According to one aspect of the present invention, all or a portion of the apparatus of exemplary embodiments of the present invention, generally operates under control of a computer program. The computer program for performing the methods of exemplary embodiments of the present invention may include one or more computer-readable program code portions, such as a series of computer instructions, embodied or otherwise stored in a computer-readable storage medium, such as the non-volatile storage medium.

It will be understood that each step of a method according to exemplary embodiments of the present invention, and combinations of steps in the method, may be implemented by computer program instructions. These computer program instructions may be loaded onto a computer or other programmable apparatus to produce a machine, such that the instructions which execute on the computer or other programmable apparatus create means for implementing the functions specified in the step(s) of the method. These computer program instructions may also be stored in a computer-readable memory that can direct a computer or other programmable apparatus to function in a particular manner, such that the instructions stored in the computer-readable memory produce an article of manufacture including instruction means which implement steps of the method. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing steps of the method.

Accordingly, exemplary embodiments of the present invention support combinations of means for performing the specified functions, combinations of steps for performing the specified functions and program instruction means for performing the specified functions. It will also be understood that each step or function, and combinations of steps or functions, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. It should therefore be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising:
a processor configured to receive data representative of points on a touch-sensitive surface with which an object comes into contact to initiate and carry out a trace or movement interaction with the surface, the trace being defined by a shape formed by the points, and the movement interaction being defined by movement reflected by the points,
wherein the processor is configured to determine if the contact is initiated to carry out a trace or movement interaction based on the data, the contact being initiated to carry out a trace if contact of the object is made and the object is held substantially in place for a period of time, the determination being made independent of a corresponding display or any media presented thereon, and
wherein the processor is configured to interpret the data based on the determination to thereby direct interaction with media presented on the corresponding display based on the interpretation.

2. The apparatus of claim 1, wherein the processor is further configured to receive data representative of points on the touch-sensitive surface with which a given object comes into contact to carry out an interaction with media presented on the corresponding display, the given object comprising the object that comes into contact to initiate or carry out the trace or movement interaction, or another object, the given object comprising a first object for effectuating a first type of interaction with the media, a second object for effectuating a second type of interaction with the media, or a third object for effectuating a third type of interaction with the media,
wherein the processor is configured to determine if the given object is the first, second or third object based on the data representative of points on the touch-sensitive surface with which the given object comes into contact, and independent of separate user input, and
wherein the processor is configured to enter a mode for interacting with the media based on the determination if the given object is the first, second or third object.

3. The apparatus of claim 1, wherein the processor being configured to receive data includes being configured to receive data to carry out a trace, the trace being defined by an S-shape, F-shape, G-shape, K-shape or M-shape, and
wherein the processor being configured to interpret the data includes being configured to interpret the data to thereby direct interaction with media presented on the corresponding display by a software application, the software application being directed to launch a study-worklist application when the trace is defined by an S-shape, launch a patient finder/search application when the trace is defined by an F-shape, direct an Internet browser to an Internet-based search engine when the trace is defined by an G-shape, launch a virtual keypad or keyboard when the trace is defined by an K-shape, or launch a measurement tool when the trace is defined by a M-shape.

4. The apparatus of claim 1, wherein the processor being configured to receive data includes being configured to receive data to carry out a trace, the trace being defined by an A- or arrow shape, a C-shape or an E-shape, and
wherein the processor being configured to interpret the data includes being configured to interpret the data to thereby direct interaction with media presented on the corresponding display by a software application, the software application being directed to annotate media presented on the corresponding display, including presentation of an annotations dialog based on the shape defining the trace.

5. The apparatus of claim 1, wherein the processor being configured to receive data includes being configured to receive data to carry out a trace, the trace being defined by a checkmark-, J- or V-shape, and
wherein the processor being configured to interpret the data includes being configured to interpret the data to thereby direct interaction with media presented on the corresponding display by a software application, the software application being directed to mark a study including the presented media with a status indicating interaction with the study has been completed.

6. The apparatus of claim 1, wherein the processor being configured to receive data includes being configured to receive data to carry out a trace, the trace being defined by a D-shape, and
wherein the processor being configured to interpret the data includes being configured to interpret the data to thereby direct interaction with media presented on the corresponding display by a software application, the software application being directed to launch a dictation application.

7. The apparatus of claim 1, wherein the processor being configured to receive data includes being configured to receive data to carry out a movement interaction, the movement interaction being defined by a two-handed, multiple-finger contact beginning at one side of the touch-sensitive surface and wiping to the other side of the surface, and
wherein the processor being configured to interpret the data includes being configured to interpret the data to thereby direct interaction with media presented on the corresponding display by a software application, to interpret the data includes being configured to interpret the data to thereby direct the software application being directed to close open media presented on the corresponding display.

8. The apparatus of claim 1, wherein the processor being configured to receive data includes being configured to receive data to carry out a movement interaction, the movement interaction being defined by a two-handed, single-finger contact whereby the finger of one hand is anchored substantially in place while dragging the finger of the other hand toward or away from the anchored finger in a substantially horizontal, vertical or diagonal direction, and
wherein the processor being configured to interpret the data includes being configured to interpret the data to thereby direct interaction with media presented on the corresponding display by a software application, the software application being directed to interactively adjust a contrast of media presented on the corresponding display when the direction is substantially horizontal, adjust a brightness of media presented on the corresponding display when the direction is substantially vertical, or adjust both the contrast and brightness of media presented on the corresponding display when the direction is substantially diagonal.

9. The apparatus of claim 1, wherein the processor being configured to receive data includes being configured to receive data to carry out a movement interaction, the movement interaction being defined by a two-handed, single-finger contact whereby the finger of one hand is anchored substantially in place while dragging the finger of the other hand toward or away from the anchored finger in a substantially horizontal, vertical or diagonal direction, and
wherein the processor being configured to interpret the data includes being configured to interpret the data to thereby direct interaction with media presented on the corresponding display by medical imaging software, the medical imaging software being directed to interactively adjust a window of media presented on the corresponding display when the direction is substantially horizontal, adjust a level of media presented on the corresponding display when the direction is substantially vertical, or adjust both the window and level of media presented on the corresponding display when the direction is substantially diagonal.

10. The apparatus of claim 1, wherein the processor being configured to receive data includes being configured to receive data to carry out a movement interaction, the movement interaction being defined by a single-handed, multiple-finger contact and dragging in the direction of another object, and
wherein the processor being configured to interpret the data includes being configured to interpret the data to thereby direct interaction with media presented on the corresponding display by a software application, the software application being directed to perform an action with respect to the other object.

11. The apparatus of claim 10, wherein the other object comprises another software application or display.

12. The apparatus of claim 1, wherein the processor being configured to receive data includes being configured to receive data to carry out a movement interaction, the movement interaction being defined by a single or two-handed, multiple-finger contact and release, and
wherein the processor being configured to interpret the data includes being configured to interpret the data to thereby direct interaction with media presented on the corresponding display by a software application, the software application being directed to open a menu of the software application, the menu being navigable by a user via single-finger contact and release relative to one of a number of options presented in the menu.

13. A method comprising:
receiving data representative of points on a touch-sensitive surface with which an object comes into contact to initiate and carry out a trace or movement interaction with the surface, the trace being defined by a shape formed by the points, and the movement interaction being defined by movement reflected by the points;
determining if the contact is initiated to carry out a trace or movement interaction based on the data, the contact being initiated to carry out a trace if contact of the object is made and the object is held substantially in place for a period of time, the determination being made independent of a corresponding display or any media presented thereon; and
interpreting the data based on the determination to thereby direct interaction with media presented on the corresponding display based on the interpretation.

14. The method of claim 13 further comprising:
receiving data representative of points on the touch-sensitive surface with which a given object comes into contact to carry out an interaction with media presented on the corresponding display, the given object comprising the object that comes into contact to initiate or carry out the trace or movement interaction, or another object, the given object comprising a first object for effectuating a first type of interaction with the media, a second object for effectuating a second type of interaction with the media, or a third object for effectuating a third type of interaction with the media;
determining if the given object is the first, second or third object based on the data representative of points on the touch-sensitive surface with which the given object comes into contact, and independent of separate user input; and
entering a mode for interacting with the media based on the determination if the given object is the first, second or third object.

15. The method of claim 13, wherein receiving data comprises receiving data to carry out a trace, the trace being defined by an S-shape, F-shape, G-shape, K-shape or M-shape, and
wherein interpreting the data comprises interpreting the data to thereby direct interaction with media presented on the corresponding display by a software application, the software application being directed to launch a study-worklist application when the trace is defined by an S-shape, launch a patient finder/search application when the trace is defined by an F-shape, direct an Internet browser to an Internet-based search engine when the trace is defined by an G-shape, launch a virtual keypad or keyboard when the trace is defined by an K-shape, or launch a measurement tool when the trace is defined by a M-shape.

16. The method of claim 13, wherein receiving data comprises receiving data to carry out a trace, the trace being defined by an A- or arrow shape, a C-shape or an E-shape, and
wherein interpreting the data comprises interpreting the data to thereby direct interaction with media presented on the corresponding display by a software application, the software application being directed to annotate media presented on the corresponding display, including presentation of an annotations dialog based on the shape defining the trace.

17. The method of claim 13, wherein receiving data comprises receiving data to carry out a trace, the trace being defined by a checkmark-, J- or V-shape, and
wherein interpreting the data comprises interpreting the data to thereby direct interaction with media presented on the corresponding display by a software application, the software application being directed to mark a study including the presented media with a status indicating interaction with the study has been completed.

18. The method of claim 13, wherein receiving data comprises receiving data to carry out a trace, the trace being defined by a D-shape, and
wherein interpreting the data comprises interpreting the data to thereby direct interaction with media presented on the corresponding display by a software application, the software application being directed to launch a dictation application.

19. The method of claim 13, wherein receiving data comprises receiving data to carry out a movement interaction, the movement interaction being defined by a two-handed, multiple-finger contact beginning at one side of the touch-sensitive surface and wiping to the other side of the surface, and
wherein interpreting the data comprises interpreting the data to thereby direct interaction with media presented on the corresponding display by a software application, the software application being directed to close open media presented on the corresponding display.

20. The method of claim 13, wherein receiving data comprises receiving data to carry out a movement interaction, the movement interaction being defined by a two-handed, single-finger contact whereby the finger of one hand is anchored substantially in place while dragging the finger of the other hand toward or away from the anchored finger in a substantially horizontal, vertical or diagonal direction, and
wherein interpreting the data comprises interpreting the data to thereby direct interaction with media presented on the corresponding display by a software application, the software application being directed to interactively adjust a contrast of media presented on the corresponding display when the direction is substantially horizontal, adjust a brightness of media presented on the corresponding display when the direction is substantially vertical, or adjust both the contrast and brightness of media presented on the corresponding display when the direction is substantially diagonal.

21. The method of claim 13, wherein receiving data comprises receiving data to carry out a movement interaction, the movement interaction being defined by a two-handed, single-finger contact whereby the finger of one hand is anchored substantially in place while dragging the finger of the other hand toward or away from the anchored finger in a substantially horizontal, vertical or diagonal direction, and
wherein interpreting the data comprises interpreting the data to thereby direct interaction with media presented on the corresponding display by medical imaging software, the medical imaging software being directed to interactively adjust a window of media presented on the corresponding display when the direction is substantially horizontal, adjust a level of media presented on the corresponding display when the direction is substantially vertical, or adjust both the window and level of media presented on the corresponding display when the direction is substantially diagonal.

22. The method of claim 13, wherein receiving data comprises receiving data to carry out a movement interaction, the movement interaction being defined by a single-handed, multiple-finger contact and dragging in the direction of another object, and
wherein interpreting the data comprises interpreting the data to thereby direct interaction with media presented on the corresponding display by a software application, the software application being directed to perform an action with respect to the other object.

23. The method of claim 22, wherein the other object comprises another software application or display.

24. The method of claim 13, wherein receiving data comprises receiving data to carry out a movement interaction, the movement interaction being defined by a single or two-handed, multiple-finger contact and release, and
wherein interpreting the data comprises interpreting the data to thereby direct interaction with media presented on the corresponding display by a software application, the software application being directed to open a menu of the software application, the menu being navigable by a user via single-finger contact and release relative to one of a number of options presented in the menu.

25. A computer-readable storage medium having computer-readable program code portions stored therein, the computer-readable program code portions comprising:
a first executable portion configured to receive data representative of points on a touch-sensitive surface with which an object comes into contact to initiate and carry out a trace or movement interaction with the surface, the trace being defined by a shape formed by the points, and the movement interaction being defined by movement reflected by the points;
a second executable portion configured to determine if the contact is initiated to carry out a trace or movement interaction based on the data, the contact being initiated to carry out a trace if contact of the object is made and the object is held substantially in place for a period of time, the determination being made independent of a corresponding display or any media presented thereon; and
a third executable portion configured to interpret the data based on the determination to thereby direct interaction with media presented on the corresponding display based on the interpretation.

26. The computer-readable storage medium of claim 25, wherein the computer-readable program code portions further comprise:
a fourth executable portion configured to receive data representative of points on the touch-sensitive surface with which a given object comes into contact to carry out an interaction with media presented on the corresponding display, the given object comprising the object that comes into contact to initiate or carry out the trace or movement interaction, or another object, the given object comprising a first object for effectuating a first type of interaction with the media, a second object for effectuating a second type of interaction with the media, or a third object for effectuating a third type of interaction with the media;
a fifth executable portion configured to determine if the given object is the first, second or third object based on the data representative of points on the touch-sensitive surface with which the given object comes into contact, and independent of separate user input; and
a sixth executable portion configured to enter a mode for interacting with the media based on the determination if the given object is the first, second or third object.

27. The computer-readable storage medium of claim 25, wherein the first executable portion being configured to receive data includes being configured to receive data to carry out a trace, the trace being defined by an S-shape, F-shape, G-shape, K-shape or M-shape, and
wherein the third executable portion being configured to interpret the data includes being configured to interpret the data to thereby direct interaction with media presented on the corresponding display by a software application, the software application being directed to launch a study-worklist application when the trace is defined by an S-shape, launch a patient finder/search application when the trace is defined by an F-shape, direct an Internet browser to an Internet-based search engine when the trace is defined by an G-shape, launch a virtual keypad or keyboard when the trace is defined by an K-shape, or launch a measurement tool when the trace is defined by a M-shape.

28. The computer-readable storage medium of claim 25, wherein the first executable portion being configured to receive data includes being configured to receive data to carry out a trace, the trace being defined by an A- or arrow shape, a C-shape or an E-shape, and
wherein the third executable portion being configured to interpret the data includes being configured to interpret the data to thereby direct interaction with media presented on the corresponding display by a software application, the software application being directed to annotate media presented on the corresponding display, including presentation of an annotations dialog based on the shape defining the trace.

29. The computer-readable storage medium of claim 25, wherein the first executable portion being configured to receive data includes being configured to receive data to carry out a trace, the trace being defined by a checkmark-, J- or V-shape, and
wherein the third executable portion being configured to interpret the data includes being configured to interpret the data to thereby direct interaction with media presented on the corresponding display by a software application, the software application being directed to mark a study including the presented media with a status indicating interaction with the study has been completed.

30. The computer-readable storage medium of claim 25, wherein the first executable portion being configured to receive data includes being configured to receive data to carry out a trace, the trace being defined by a D-shape, and
wherein the third executable portion being configured to interpret the data includes being configured to interpret the data to thereby direct interaction with media presented on the corresponding display by a software application, the software application being directed to launch a dictation application.

31. The computer-readable storage medium of claim 25, wherein the first executable portion being configured to receive data includes being configured to receive data to carry out a movement interaction, the movement interaction being defined by a two-handed, multiple-finger contact beginning at one side of the touch-sensitive surface and wiping to the other side of the surface, and
wherein the third executable portion being configured to interpret the data includes being configured to interpret the data to thereby direct interaction with media presented on the corresponding display by a software application, to interpret the data includes being configured to interpret the data to thereby direct the software application being directed to close open media presented on the corresponding display.

32. The computer-readable storage medium of claim 25, wherein the first executable portion being configured to receive data includes being configured to receive data to carry out a movement interaction, the movement interaction being defined by a two-handed, single-finger contact whereby the finger of one hand is anchored substantially in place while dragging the finger of the other hand toward or away from the anchored finger in a substantially horizontal, vertical or diagonal direction, and
wherein the third executable portion being configured to the data includes being configured to interpret the data to thereby direct interaction with media presented on the corresponding display by a software application, the software application being directed to interactively adjust a contrast of media presented on the corresponding display when the direction is substantially horizontal, adjust a brightness of media presented on the corresponding display when the direction is substantially vertical, or adjust both the contrast and brightness of media presented on the corresponding display when the direction is substantially diagonal.

33. The computer-readable storage medium of claim 25, wherein the first executable portion being configured to receive data includes being configured to receive data to carry out a movement interaction, the movement interaction being defined by a two-handed, single-finger contact whereby the finger of one hand is anchored substantially in place while dragging the finger of the other hand toward or away from the anchored finger in a substantially horizontal, vertical or diagonal direction, and
wherein the third executable portion being configured to the data includes being configured to interpret the data to thereby direct interaction with media presented on the corresponding display by medical imaging software, the medical imaging software being directed to interactively adjust a window of media presented on the corresponding display when the direction is substantially horizontal, adjust a level of media presented on the corresponding display when the direction is substantially vertical, or adjust both the window and level of media presented on the corresponding display when the direction is substantially diagonal.

34. The computer-readable storage medium of claim 25, wherein the first executable portion being configured to receive data includes being configured to receive data to carry out a movement interaction, the movement interaction being defined by a single-handed, multiple-finger contact and dragging in the direction of another object, and
wherein the third executable portion being configured to interpret the data includes being configured to interpret the data to thereby direct interaction with media presented on the corresponding display by a software application, the software application being directed to perform an action with respect to the other object.

35. The computer-readable storage medium of claim 34, wherein the other object comprises another software application or display.

36. The computer-readable storage medium of claim 25, wherein the first executable portion being configured to receive data includes being configured to receive data to carry out a movement interaction, the movement interaction being defined by a single or two-handed, multiple-finger contact and release, and
wherein the third executable portion being configured to interpret the data includes being configured to interpret the data to thereby direct interaction with media presented on the corresponding display by a software application, the software application being directed to open a menu of the software application, the menu being navigable by a user via single-finger contact and release relative to one of a number of options presented in the menu.
